(19) United States
(12) Patent Application Publication
(10) Pub. No.: US 2015/0012963 A1
(43) Pub. Date: Jan. 8, 2015

(54) MANAGING SECURE, PRIVATE COMMUNICATIONS IN TELECOM INFORMATION MANAGEMENT SYSTEM

(71) Applicant: Amtel, Inc., Santa Clara, CA (US)

(72) Inventors: Pankaj GUPTA, San Jose, CA (US); Richa GUPTA, San Jose, CA (US)

(21) Appl. No.: 13/935,335

(22) Filed: Jul. 3, 2013

(51) Int. Cl. H04L 29/06

(52) U.S. Cl. CPC H04L 63/20
USPC 726/1

(57) ABSTRACT

The disclosed Telecom Information Management System (TIMS) integrates Mobile Expense Management (MEM), Mobile Device Management (MDM) and Telecom Expense Management (TEM) solutions in a single software platform, which can be delivered to enterprises as software-as-a-service (SaaS). In some implementations, TIMS can be used to facilitate communication between two or more devices. TIMS can receive a request from a first client device to communicate with a second client device in a group of client devices associated with an enterprise; determine that the first and second client devices comply with a set of rules for the group that are specified by an administrator of the enterprise; and establish voice, chat, data and/or video communication between the first client device and the second client device.

### TECHNICAL FIELD

This disclosure relates generally to telecommunication systems management.

### BACKGROUND

Mobile and wireless networks are increasingly being utilized by business enterprises to facilitate communication and productivity. Due to the increasing use of mobile devices, Mobile Expense Management (MEM) and Mobile Device Management (MDM) have become increasingly difficult for enterprises. There are issues of mobile security, application security, usage charges, secure communication between diverse mobile devices, high international roaming charges and the management of a large number of different platforms with different configurations, features and subscriber plans.

Many modern mobile devices include processors and operating systems for running various applications. Additionally, many modern mobile devices include one or more positioning technologies that allow the geographic locations of the mobile devices to be tracked in real time. These powerful mobile device capabilities provide additional mechanisms that can be leveraged to improve upon MEM and MDM solutions.

### SUMMARY

The disclosed Telecom Information Management System (TIMS) integrates MEM, MDM and TEM solutions in a single software platform, which can be delivered to enterprises as software-as-a-service (SaaS) in a private or public network. In some implementations, TIMS can be used to facilitate communication between two or more devices. TIMS can receive a request from a first client device to communicate with a second client device in a group of client devices associated with an enterprise; determine that the first and second client devices comply with a set of rules for the group that are specified by an administrator of the enterprise; and establish voice, chat, data and/or video communication between the first client device and the second client device.

In some implementations, a method comprises: receiving a request from a first client device to communicate with a second client device in a group of client devices associated with an enterprise; determining that the first and second client devices comply with a set of rules for the group that are specified by an administrator of the enterprise; and establishing voice or data or video or messaging communication between the first client device and the second client device.

In some implementations, a method comprises: establishing communication with a device; sending a link to the device; receiving input indicating the link was selected at the device; responsive to the input, securing the device according to a first set of rules implementing an enterprise security policy; and installing a software application on the device, the software including a second set of rules for communicating with other devices in a group of devices associated with the enterprise.

In some implementations, a method comprises: establishing communication with a server computer; receiving a link from the server computer; receiving input indicating the link was selected at the device; responsive to the input, allowing the server computer to perform security operations according to a first set of rules implementing an enterprise security policy; receiving a software application from the server computer, the software including a second set of rules for communicating with other devices in a group of devices associated with the enterprise; and launching the software application on the device to enable the device to communicate with the other devices according to the second set of rules.

Other implementations are directed to systems and computer-readable mediums.

Particular implementations of TIMS provide one or more of the following advantages. TIMS allows enterprise administrators to specify rules for managing groups of client devices associated with the enterprise, including rules for allowing communications (e.g., voice, chat, data, video) between client devices in the group.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 is an exemplary operating environment for TIMS.

FIG. 2 illustrates the TIMS platform.

FIG. 3 illustrates mobile device management services/applications provided by TIMS.

FIG. 4 is a flow diagram of an exemplary process performed by TIMS for aggregating expense and device management information and reporting.

FIG. 5 is a flow diagram of an exemplary process performed by TIMS for processing alerts.

FIG. 6 is a flow diagram of an exemplary process performed by a mobile device for generating alerts.

FIG. 7 is a flow diagram of an exemplary process for recording calls.

FIG. 8 is an example customizable dashboard for displaying reports.

FIG. 9 is a block diagram of an exemplary device architecture that implements the features and processes described with reference to FIGS. 1-7.

FIG. 10 is an exemplary operating environment for secure, private voice communications.

FIG. 11 is a flow diagram of an exemplary process of managing secure, private voice or video or messaging communications.

FIG. 12 is a flow diagram of an exemplary process performed by a server computer for securely enrolling a device for communications with other devices in a group managed by TIMS.

FIG. 13 is a flow diagram of an exemplary process performed by a device for securely enrolling the device for communications with other devices in a group managed by TIMS.

### DETAILED DESCRIPTION

### TIMS Operating Environment

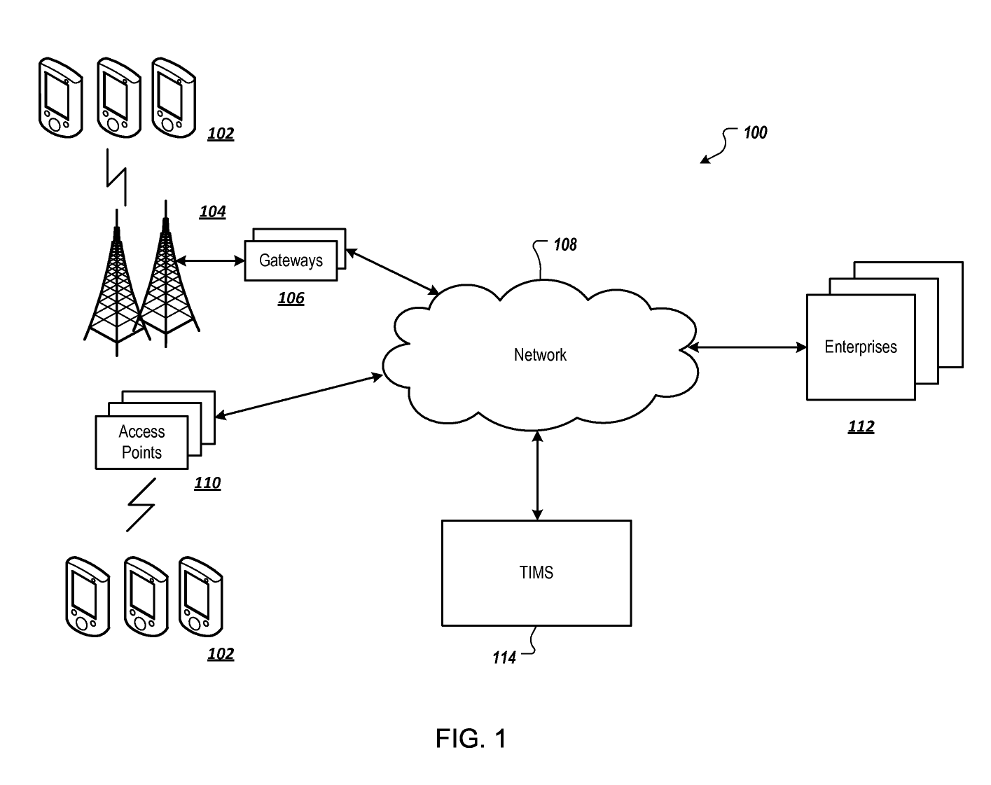

FIG. 1 is an exemplary operating environment 100 for TIMS. In some implementations, operating environment 100 includes mobile devices 102 coupled to network 108 through cellular towers 104 and gateways 106 or access points 110 (e.g., WiFi router). TIMS 114 and enterprises 112 are each coupled to network 108 (e.g., Internet, switched phone network, text messaging network). Mobile devices 102 can be any device capable of communicating voice, data or text messages over network 108. Network 108 includes the equipment (e.g., routers, hubs, servers) and software for facilitating communication of voice or data between devices and services coupled to network 108. Enterprises 112 can be any business that uses TIMS 114 to manage mobile devices 102 and related expenses.

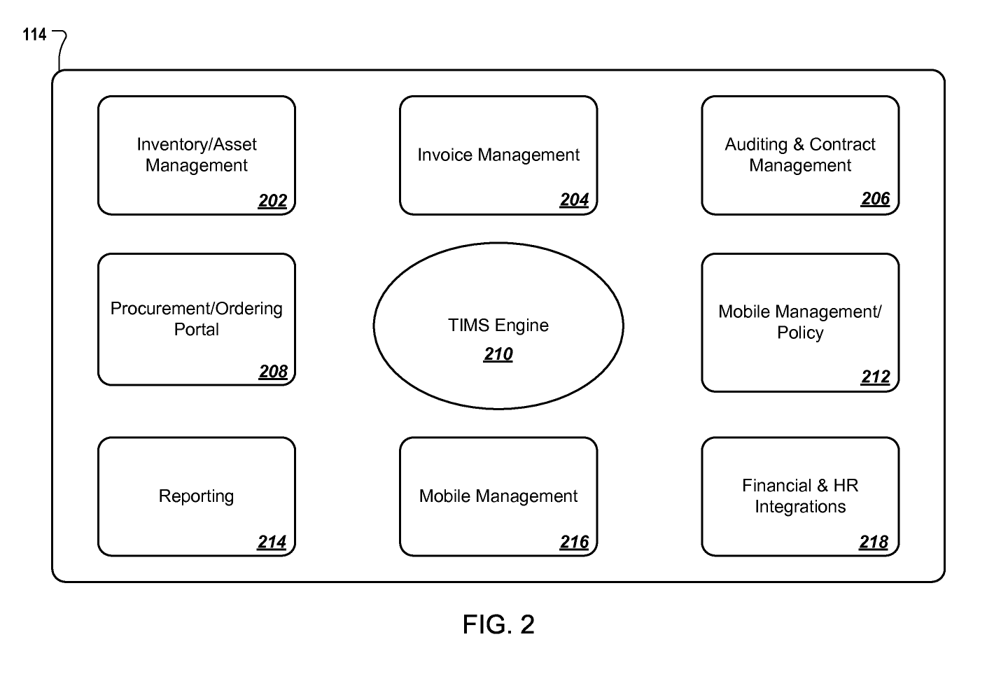

FIG. 2 illustrates TIMS 114, which can include the following services: inventory/asset management 202, invoice management 204, auditing/contract management 206, procurement/ordering portal 208, mobile management/policy 212, reporting 214, mobile device management 216 and financial/human resources integrations 218. These services are supported by TIMS engine 210, which is a software platform that integrates landline and mobile systems.

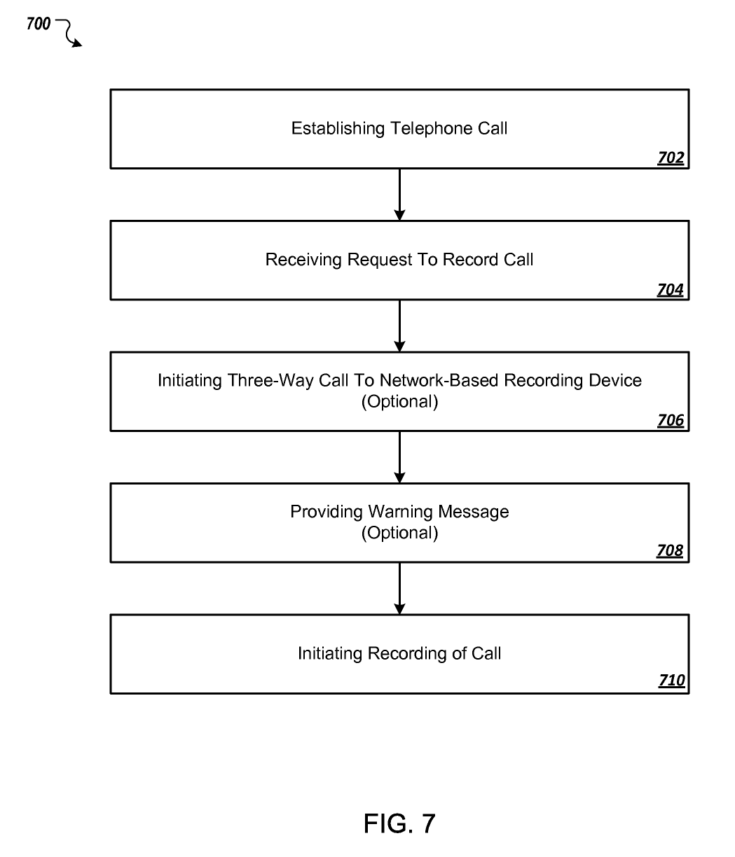

In some implementations, TIMS 114 is a multi-tenant platform residing in public or private network of servers that uses common resources to support multiple customers simultaneously. The platform can include a technology stack comprising servers, switches, bandwidth, storage, etc. Each customer can have one or more dedicated databases separate from other customer databases. Interactive applications (e.g., MDM applications) provided to customers can be developed using Asynchronous JavaScript and eXtensible Markup Language (XML) or AJAX, or other suitable known technologies. Enterprise data can be kept secure using symmetric-key and public-key encryption and Transport Layer Security (TLS), including Hypertext Transfer Protocol over Secure Socket Layer (HTTPS) and File Transfer Protocol (FTP). In some implementations, SaaS applications can be integrated with back-office systems to achieve automation. For example, SaaS applications can integrate data or functionality from other applications through use of mashups, where widgets or small subsets of data/functionality are incorporated into a single viewable screen, such as the dashboard shown in FIG. 7.

Inventory/asset management 202 manages inventory and assets for enterprises 112. Assets can include but are not limited to: mobile and landline handsets; data circuits; Multiprotocol Label Switching (MPLS); Voice-Over-Internet Protocol (VoIP); calling cards; conferencing; pagers; eFax; long distance calls; and Web hosting. TIMS 114 can maintain and update inventory as mobile devices 102 are acquired by enterprises 112. For example, TIMS 114 can track the number and types of mobile devices 102 (e.g., smart phone, ordinary phone, electronic tablet, pager, e-mail device) operated by an enterprise, including the capabilities of those devices (e.g., GPS capability), the applications installed on those devices (e.g., call redirectors) and the carriers (e.g., AT&T®, Verizon®) supporting those devices. Enterprises 112 can receive an overview of its inventory through a Web interface, such as the customizable dashboard described in reference to FIG. 7.

Procurement/ordering portal 208 facilitates corporate hierarchical order management workflow; manages moves, adds, changes and disconnects (MACDs); automates order routing to carriers; centralized procurement controls; and distributes site administration configurations for multi-locations.

In some implementations, procurement/ordering portal 208 includes initializing orders to install an MDM application on a device based on active lines in an enterprise's mobile invoice and inventory. Orders can be placed based on carrier type, subscriber plans, spend allowed, profile type and the like. MDM applications can be installed on individual devices to allow the enterprise to control the devices which employees may be using for company purposes and may or may not contain company related information.

Mobile management/policy 212 implements mobile usage policy, including but not limited to: setting up corporate policies, such as limits on plan types and device types based on profiles; marking personal calls; segregating personal calls from corporate calls; mobile applications or third party software charges identification for each mobile subscriber; 411 charges, ring tones and international roaming charges separation; automated reports of non-approved usage to end-mobile subscribers or managers; and split charges reporting to accounts payable.

In some implementations, mobile management/policy 212 allows set up of different limits on mobile usage based on time of day, usage charges, call types, profile types, and implements these functions in real time using software applications (also referred to as MDM applications) installed on the mobile device.

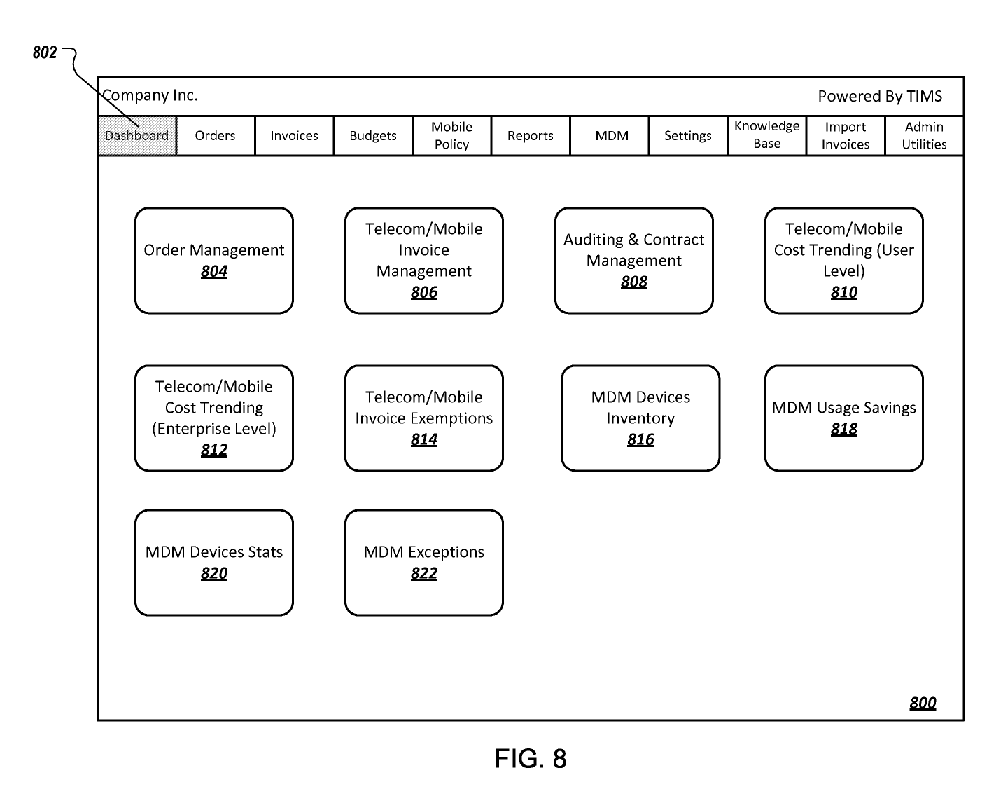

Reporting 214 includes but is not limited to: generating business intelligence reports; role based hierarchical reporting (e.g., mobile subscriber, manager, administrator); administrative level reports; end mobile subscriber reports; ad-hoc reports, customized reports, budgeting and forecasting; and automated scheduling of reports. The administrative level reports can be displayed in a customized dashboard, as described in reference to FIG. 8. Reporting can use a push or pull mechanism. Reports can be provided in a variety for formats (e.g., Excel, CSV, PDF, Word, XML, TIFF, MHTML). Reports can be scheduled to be emailed automatically (e.g., daily, weekly, monthly).

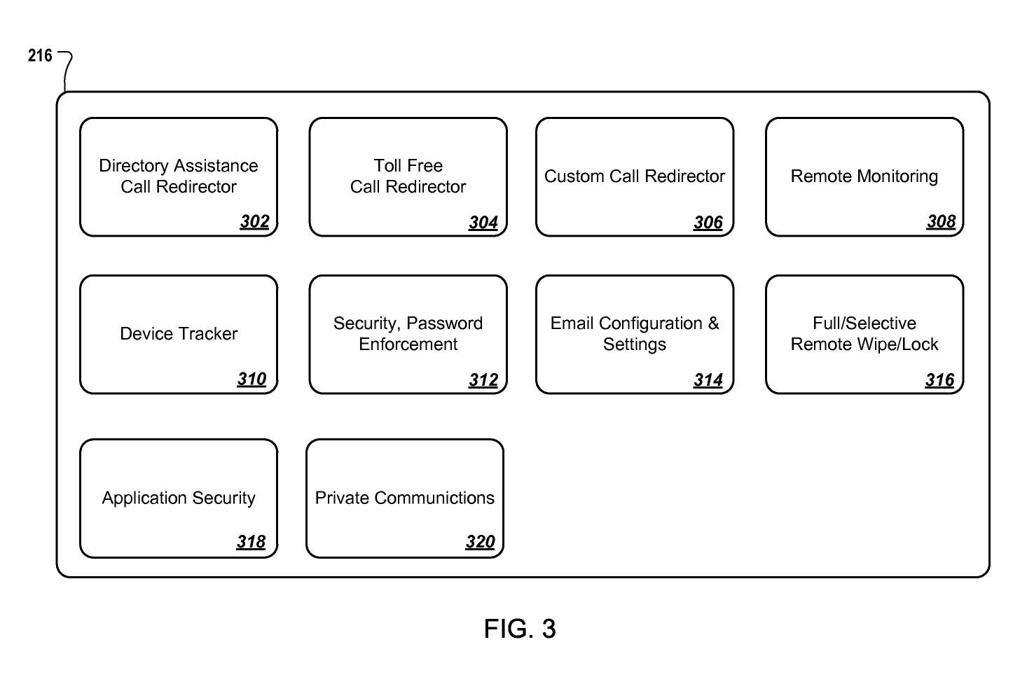

In some implementations, reporting 214 generates reports showing the savings realized by MDM versus actual mobile invoices for 411, international call and custom redirects and international roaming alerts, as described in reference to FIG. 3. Reports can be generated for any remote wipes of a device after the device has been disconnected in the carrier network due to any issue including invoice issues created by malicious calls, lost device, or other security reasons. Reports can be generated for location coordinates of mobile devices at various time intervals.

Financial and human resources (HR) integration 218 includes but is not limited to: integration with financial systems of the enterprise, feeds from an HR system regarding hierarchy changes, terminations, new hires and other HR functions; and administrator and mobile subscriber level logins.

Mobile device management 216 includes a number of mobile device and expense management services/applications, as described in reference to FIG. 3.

### Mobile Device Management

FIG. 3 illustrates MDM applications provided by TIMS 114. In some implementations, MDM 216 provides various MDM applications and/or configuration data that can be installed on mobile devices 102 to support mobile management 216, including but not limited to: directory assistance call redirector application 302; toll free call redirector application 304; custom call redirector application 306; remote monitoring application 308; device tracker application 310; security/password enforcement 312; e-mail configuration/settings 314; full/selective remote wipe/remote lock 316; application security 318; and private communications 320.

Private communications 320 can include features for establishing secure, private communications between devices in a group. Private communications 320 can create private groups of user or devices within an enterprise for enabling secure, private communications. Private communications 320 can setup calling restrictions for a user or device within a group of users or devices. For example, restrictions can specify which users in a group can be called by a given device in the group, and which users in the group can call the given device. Private communications 320 can add or remove phone numbers in a server console operated by an administrator to create restrictions for calling on devices based on telephone numbers (incoming/outgoing). Private communications 320 can create restrictions on devices based on users (e.g., names, device IDs). Private communications 320 can create restrictions for calling on devices based on operating systems. For example, Android® phone users can only call other Android phone users or Android and Apple iPhone® users. Private communications 320 can determine whether a phone number is enabled for secure, private communications or calling on a public network (e.g., PSTN).

In some implementations, private communications 320 can push a set of rules on devices affecting calling behavior on the device. The restrictions and rules can be pushed to the devices and updated by a remotely located server computer in TIMS 114. Some examples of rules include but are not limited to: 1) the device is compromised (e.g., jail broken, rooted); 2) the device is at a certain geographic location; 3) the device has a black listed application installed; 4) the device does not have certain mandatory applications installed; and 5) the subscriber identity module (SIM) or other subscriber or carrier identification module has been swamped.

In some implementations, private communications 320 can report and play call recordings from devices from an administrator console at TIMS 114.

Directory assistance and toll calls can be expensive. To reduce costs TIMS 114 can download directory assistance call redirector application 302 onto mobile devices 102, which is configured to redirect directory assistance calls to free or reduced cost directory assistance lines and services. The application monitors input on the mobile device (e.g., a smart phone) for known directory assistance numbers, such as “411” or “1-(xxx)-555-1212,” and replaces these number with a free service number, such as “1-800-Free411.”

TIMS 114 can also download toll free call redirector application 304 to mobile devices 102 to redirect toll calls to a toll free or lower cost service. For example, when a mobile subscriber inputs a telephone number with an area code, the number can be compared to a list of alternative toll free numbers (e.g., “1-800-xxx-xxxx”) for the entity being called and then redirected to the toll free number. In some implementations, toll free numbers (e.g., “1-800-xxx-xxxx”) can be redirected to a toll number. For example, when a mobile subscriber inputs a toll free telephone number to their enterprise, the number can be redirected to the toll number to save incoming toll free charges to an enterprise. In some implementations, international calls from a mobile device can be redirected to a virtual Private Branch Exchange (PBX) or enterprise phone system or virtual calling card to complete the call and avoid high international carrier rates.

TIMS 114 can also download custom call redirector application 306, which allows an enterprise administrator to provide an alternative numbers for call redirection. For example, when a mobile subscriber enters a certain number sequence (e.g., “121”), the call can be redirected to a telephone number for a Global IT Helpdesk operated by the enterprise.

In some implementations, TIMS 114 can download remote monitoring application 308 to mobile devices 102, including current subscriber plan information. An enterprise administrator can select the parameters of a given mobile device to be monitored by application 308. Various alerts related to the subscriber plan information can be sent to TIMS 114. For example, alerts can occur when a mobile subscriber travels to a country not covered by the current subscriber plan and attempts to make a call. The location of the mobile device can be determined by device tracker application 310 (e.g., GPS receiver). When device tracker application 310 indicates that a call has been initiated outside the mobile subscriber's home country, application 308 can review the subscriber plan information stored on the mobile device, or accessed through a back link to TIMS 114, to determine if the subscriber plan allows for international roaming. If the subscriber plan information indicates that the mobile subscriber does not allow for international roaming, then application 308 can send an alert to the mobile subscriber and/or TIMS 114 indicating the deficiency. Responsive to the alert, TIMS 114 can initiate an action, such as creating an order to the carrier to add an international roaming plan on the mobile device or creating an order to the carrier requesting that carrier services for the mobile device be suspended. The orders can be created manually by an enterprise administrator or automatically by TIMS 114 in response to an alert. Application 308 can also take direct action like stopping the mobile subscriber from making international calls on the mobile device by remotely disabling one or more calling parameters on the mobile device.

In some implementations, device tracker application 310 can be installed on mobile devices 102 by TIMS 114. Application 310 can hook into a location services Application Programming Interface (API) for the mobile device to collect position coordinates determined by a positioning system, such as Global Positioning System (GPS) or WiFi positioning. An enterprise administrator can select time intervals for location capture and reporting to TIMS 114 using a Web-based service provided by TIMS 114. The position coordinates can be used to plot locations of the mobile device at specified time intervals on a map display, which can be served to enterprise administrators through the Web-based service.

In some implementations, security password/enforcement 312 allows enterprise administrators to configure remotely mobile devices 102 through TIMS 114 Web interfaces to implement password policies, restrict access to certain mobile device features and to send alerts when SIM cards have been changed on the mobile device.

In some implementations, email configuration and settings application 314 allows TIMS 114 to configure remotely email and settings applications of a mobile device. For example, application 314 can allow TIMS 114 to set up, change and remove email accounts, reset passwords, change access rules and the like. TIMS 114 can also facilitate remote changing of communication settings (e.g., WiFi or VPN settings) or directory service settings (e.g., LDAP directory service settings) on a mobile device, or any other settings that would be normally accessible by the mobile subscriber through a settings page (e.g., language, voice control, region format, calendar, accessibility, notifications, location services, personal hotspot, data roaming)

In some implementations, full/selective remote wipe/remote lock application 316 allows TIMS 114 to perform a remote wipe or lock of mobile devices 102. Many smart phones include an API that allows for remote wiping and locking from over a network. Application 316 hooks into this API to enable remote wipe or lock. In some implementations, an enterprise administrator can initiate a selective partial remote wipe or lock where only specific applications or features are wiped or locked out. In other implementations, full/selective remote wiping can be performed by software without using an API of the mobile device operating system.

In some implementations, application security 318 can provide a list of approved MDM applications that can be installed on the mobile devices and impose restrictions on those applications. For example, when a user attempts to download or install an application from an online application store (e.g., iTunes™), a list of allowed applications is reviewed. The list can be stored on the mobile device or accessible through a link to TIMS 114. If the application to be installed on the mobile device is not on the approved list, the application is prevented from being installed. Likewise, if a restricted feature of an installed application is invoked, the feature can be blocked from being invoked.

In some implementations, the administrator can provide a list of in-house enterprise applications that need to be installed on the mobile device 102 through TIMS 114 (e.g., in-house sales tracking system). These applications can be enterprise applications, which are not made available to the general public. The list can be stored on mobile device 102 or accessible through a link to TIMS 114. A list of installed applications are known to TIMS 114, and each time a new application is installed or an existing application is removed from mobile device 102, application security 318 notifies TIMS 114 so the list can be updated.

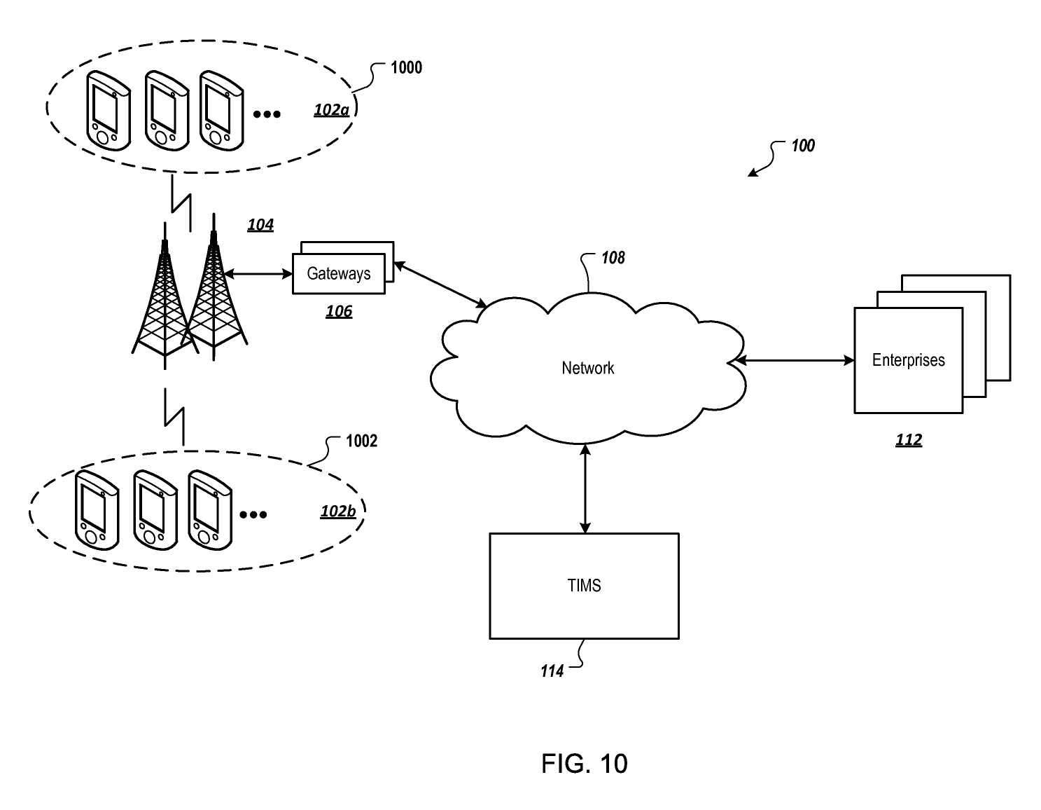

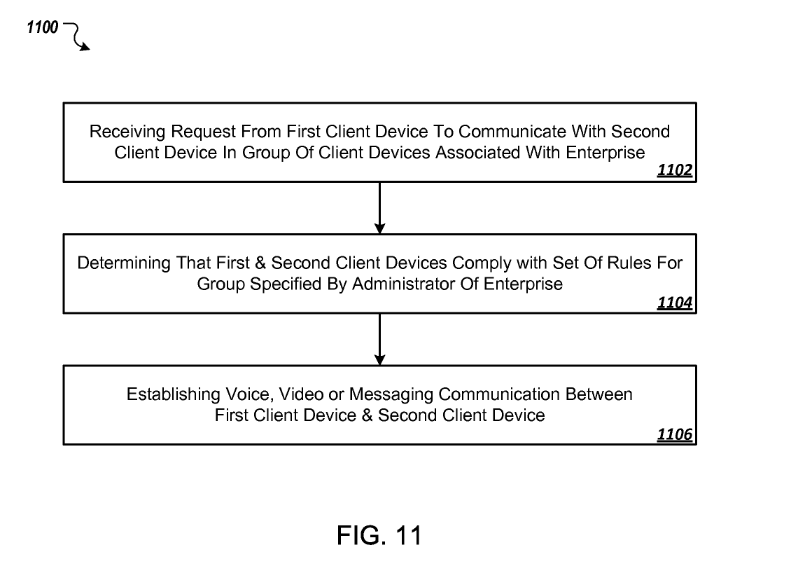

Private communications 320 allows enterprise administrators to manage groups of client devices based on a set of rules specified by an enterprise administrator, as described in reference to FIGS. 10 and 11.

Mobile device management 216 described above is integrated with TEM functions of TIMS 114. For example, decision making can be based on subscriber plans activated for the mobile device in the customer's mobile network, and mobile policy instituted by the customer for each user, which in turn is based on mobile invoice spend, including, usage type, calling times, US/International data, text and Short Message Service (SMS) limits.

Configuration of a mobile device can be based on a profile of the user, which in turn is based on country, region, carrier type, subscriber plans, other data variables in telecom invoices like GL charge codes, etc.

Configuration of an MDM profile can be based on data in calling cards for an international call re-director, such as application 304 described above. Reporting can be based on carrier invoice data in TIMS 114 compared to MDM savings realized by MDM applications on the mobile device by call redirectors, call logs, etc.

### Exemplary Processes

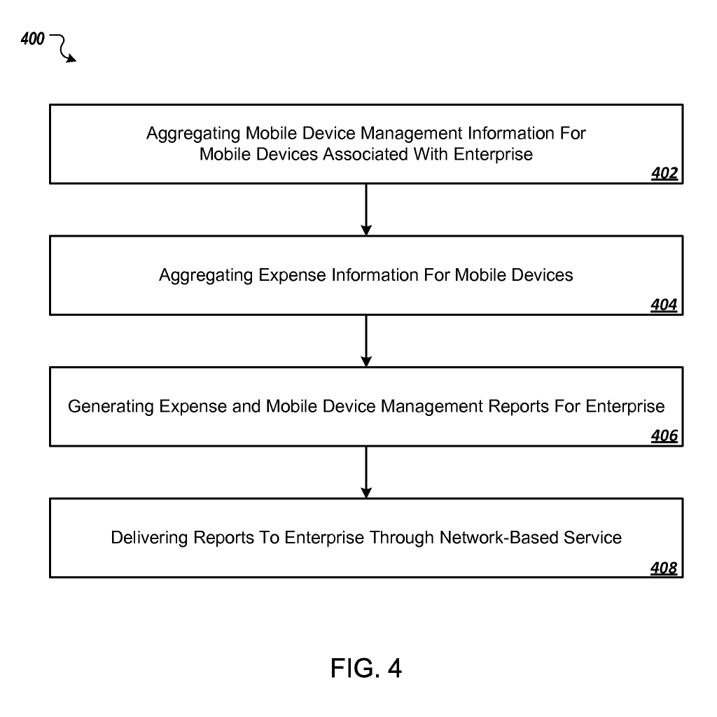

FIG. 4 is a flow diagram of an exemplary process 400 for aggregating expense and device management information and reporting. Process 400 can be performed at least in part by TIMS 114.

Process 400 can begin by aggregating MDM information for mobile devices associated with an enterprise (402). For example, an MDM application running on the mobile device can be configured to monitor certain parameters or activities of the mobile device and provide reports to TIMS 114. MDM information can include any information related to the mobile device, including but not limited to: the number and types of applications installed on the device, attempts to make certain types of calls on the device (e.g., international roaming, toll calls, directory assistance), call logs, mobile policy violations, location information, SIM card changes, security violations, etc.

Process 400 can continue by aggregating expense information related to the mobile devices (404). For example, various sources of TEM information can be received by TIMS 114, such as carrier invoice data (e.g., monthly charges), carrier plan data, etc.

Process 400 can continue by generating expense and mobile management reports for the enterprise (406), and delivering the reports to the enterprise through a network-based service (408). For example, the MDM information can be combined with TEM information to support: 1) management decisions made based on carrier plans activated for the mobile device in the mobile network of the enterprise; 2) management decisions made based on mobile policy instituted by the enterprise for each user which is in turn based on mobile invoice spend, usage type, calling times, US versus international data and text or SMS limits; 3) device configuration based on user profiles which in turn is based on country, region, carrier type, carrier plans and other data variables in carrier invoices (e.g., GL charge codes); 4) device configuration of an MDM profile for a mobile device based on data in calling cards for international call redirectors; and 5) reporting based on carrier invoice data in TIMS 114 compared to the MDM savings realized by an MDM application on the mobile device by call redirectors, call logs, etc. Once the reports are generated, they can be made available to the enterprise through a Web service.

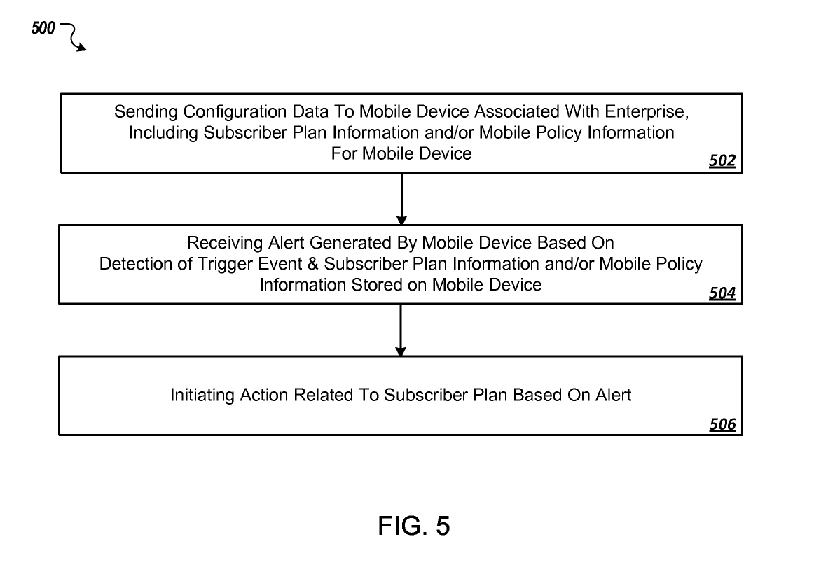

FIG. 5 is a flow diagram of an exemplary process 500 for processing alerts performed by TIMS 114. In some implementations, process 500 can begin by sending configuration data for a mobile device in a mobile network of an enterprise, including subscriber plan information and/or mobile policy information for the mobile device (502). For example, an enterprise administrator can use TIMS 114 Web service to configure remote monitoring of certain parameters and processes on the mobile device and to set up real time mobile usage policy enforcement, such as restricting usage of certain functions or applications on the mobile device to a specific time of day or restricting the mobile device usage to certain call types or profile types. In some implementations, configuration data can include configuring call redirector applications, such as designating alternative telephone numbers (e.g., free toll number).

Process 500 can continue by receiving an alert generated by a mobile device based on detection of a trigger event and subscriber plan information and/or mobile policy information stored on the mobile device (504). Based on the alert, an action can be initiated relating to the subscriber plan (506). For example, a trigger event can be a user's attempt to make an international roaming call. When the attempt is made, the subscriber plan information stored on the mobile device is reviewed to determine if the device has an international roaming plan. If not, an alert can be sent to TIMS 114 indicating the problem.

Responsive to the alert, an order can be manually or automatically generated and sent to the carrier for a subscriber plan upgrade or for suspending the subscriber account. Another example is an alert that is generated when the user attempts to change the SIM card on the mobile device. This action causes the alert to be sent to TIMS 114 so that an action can be taken, such as disabling certain calling parameters on the mobile device. Other alerts are also possible.

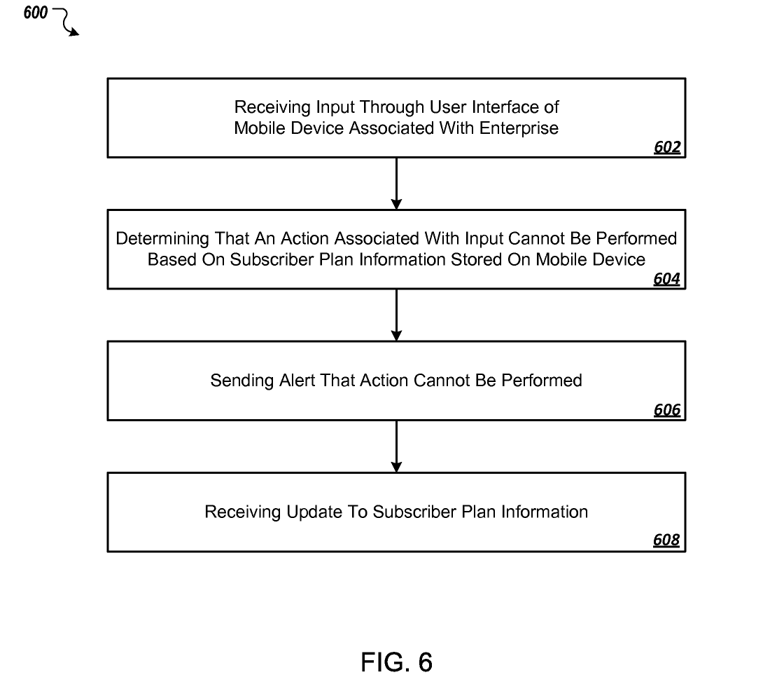

FIG. 6 is a flow diagram of an exemplary process 600 for processing alerts performed on a mobile device. Process 600 can be implemented in the mobile device architecture described in reference to FIG. 16.

Process 600 can begin by receiving an input (e.g., telephone number) through a user interface of a mobile device associated with an enterprise (602). For example, the mobile device can be a smart phone running a telephony application that presents a virtual keyboard for entering a telephone number to make a voice call or send a text message or other data (e.g., digital images).

Process 600 can continue by determining that an action associated with the input (e.g., make a call, send text message or other data) cannot be performed based on subscriber plan information stored on the mobile device (604). For example, the area or country code of the telephone number can be compared with the subscriber plan information to determine if the telephone call requires international roaming. Likewise, if the user attempts to send a text message or other data (e.g., digital images) with the telephone number or an SMS short code, the subscriber plan information can be checked to determine that the mobile subscriber has a data plan that allows text messaging.

Process 600 can continue by sending an alert to TIMS 114 that the requested action cannot be performed (606). TIMS 114 can then take action as described in reference to FIG. 5. Once the subscriber plan is updated by the carrier, the subscriber information on the mobile device can be updated by TIMS 114 (608).

Process 600 can also apply to remote monitoring of other calling parameters or features of the mobile device and sending alerts when certain trigger events occur. For example, if the user makes many toll calls but does not have toll free call redirector application 304 installed, an alert can be sent to TIMS 114. TIMS 114 can then take action such as downloading toll free call redirector application 304 to the mobile device.

### Recording Telephone Calls

FIG. 7 is a flow diagram of an exemplary process 700 for recording calls. In some implementations, a recording application can be installed on a mobile device that allows a user to initiate recording of an ongoing telephone call to local storage (e.g., flash memory) of the mobile device or to a network storage device managed by TIMS 114 or the enterprise. Recording to a network storage device can be accomplished by initiating a three-way call to a telephone number associated with the network storage device. When invoking the application the user can select an option to record locally or to record remotely. If remote recording is selected, the recording application will automatically initiate a three-way call to the recording device. In some implementations, a message can be generated for the participants warning that the conversation is about to be recorded.

Referring to FIG. 7, process 700 can begin by establishing a phone call between a first mobile device and a second mobile device (702). Process 700 can continue receiving a request to record the call (704). The request can be initiated by the first or second mobile device. For example, a call recording MDM application can be invoked by the user through an icon on a home screen. Process 700 can continue by either recording the call to local storage or initiating a three-way call to a network-based recording device operated by TIMS 114 or the enterprise (706). Process 700 can continue by providing an optional warning message (708), alerting the call participants that the call will be recorded. The warning can include a request for confirmation by one or more participants of their acceptance of the recording by providing confirming input through a keyboard of the mobile device or confirming orally by speaking the confirmation in a microphone or receiver of the mobile device, such as “I accept” or “yes.” Process 700 can continue by initiating recording of the call (710). Initiating the recording can include sending a command to TIMS 114 or by invoking a local recording application for recording to local storage (e.g., flash memory).

### Example Dashboard Display

FIG. 8 is an example customizable dashboard for displaying reports. In some implementations, when reports are generated based on MDM information and TEM information, the reports can be provided through a networked-based service, such as Web service over the Internet. The reports can be displayed in a “dashboard” page 800 (e.g., a Web page) by selecting a “Dashboard” button in page selector 802. Dashboard page 800 can include one or more widgets. The number and types of widgets can be customized by the user. The widgets can display various types of graphs to indicate values, such as pie charts, bar graphs and plots, or any other suitable graph type or format.

In the example shown, ten widgets 804-822 are displayed in dashboard page 800 in a grid format. The user, however, can arrange the widgets in dashboard 800 by touching or clicking on the widgets and dragging the widgets to a desired location in dashboard page 800. In some implementations, widgets can include but are not limited to: order management widget 804, telecom/mobile invoice management widget 806, auditing & contract management widget 808, telecom/mobile cost trending (user level) widget 810, telecom/mobile cost trending (enterprise level) widget 812, telecom/mobile invoice exceptions widget 814, MDM device inventory widget 816, MDM usage savings widget 818, MDM device statistics widget 820 and MDM exceptions widget 822.

Order management widget 802 can display status of various orders placed in the enterprise for different telecom services. The orders can also be sorted in a variety of ways by service type, carrier, user, order status, etc. In some implementations, orders can be exported into different file formats.

Telecom/mobile invoice management widget 806 can display listings of various telecom/mobile invoices for an enterprise and the invoices trending in terms of costs, carriers, services, etc.

Auditing & contract management widget 808 can display various auditing and contract related issues and their resolution with the carriers for different telecom/mobile services in the enterprise, including but not limited to billing tickets opened and credits received.

Telecom/mobile cost trending (user level) widget 810 can display various sorting of telecom usages made by the users in the enterprise including highest usage users, zero usage users, etc.

Telecom/mobile cost trending (enterprise level) widget 812 can display trending of various parameters of costs associated with different telecom services in the enterprise related to actual invoices from the carriers.

Telecom/mobile invoice exceptions widget 814 can display exceptions for various parameters of costs associated with different telecom services invoices in the enterprise from the carriers.

MDM devices inventory widget 816 can display various mobile devices enrolled for MDM at the enterprise.

MDM usage savings widget 818 can display various types of savings realized with MDM, including but not limited to “411” usage redirection, international usage redirection, international roaming alerts, etc., compared against actual invoices.

MDM device statistics widget 820 can display various real time statistics of mobile device like minutes used, data usage, international usage, text messages, features, etc.

MDM exceptions widget 822 can display various exceptions arising on various mobile devices. Some implementations include comparing actual subscriber plans with real time usage.

Widgets 802-822 described above, and other widgets, are feasible because of the integration of TEM and MDM in a single multi-tenant, platform that aggregates raw MDM and TEM information from various sources, including MDM applications residing on mobile devices and existing systems of the enterprise. Using dashboard page 800, an enterprise administrator can get a comprehensive view of both the management and expenses of enterprise mobile network through a network-based service without requiring the enterprise to add hardware or software to its existing infrastructure.

### Inventory Page

In some implementations, page selector 802 can be used to select an inventory page that allows users to view various details about inventory, including monthly charges for each device. The inventory page view can be managed by various user-selected filters. The user can select filters for displaying, for example, all locations and all users. In response to the selection, a table can be displayed listing all mobile devices at all locations of Company Inc. In some implementations, the table can include columns for service type, vendor, account #, reference#, monthly charges and status. Note that expense data can be merged with inventory data in the table. This merging of data is made possible by the integration of TEM and MDM in TIMS 114.

In some implementations, the inventory page can be displayed in a grid view, where additional information can be displayed, including a first column for listing the MDM features installed on the mobile device, device network statistics, logs, mobile third party applications installed on the device, enterprise applications installed on the device, device health monitoring statistics, active processes running on the device, activity associated with the device, and the like. A second column can be used for placing orders. A third column can be used to display monthly charges.

### MDM Reports Page

In some implementations, page selector 802 can be used to select an MDM reports page that includes a numerical listing of available MDM reports that can be selected by the user for display. One MDM inventory report can provide MDM information for devices on the mobile network, which can then be filtered by the user. Another MDM report can allow a user to specify a time interval for tracking a mobile device location using, for example, GPS. Other reports provide summaries and details of call redirectors installed on the mobile device, including directory assistance redirector, international call redirector and toll-free redirector. Each of these reports can be filtered by date range, mobile vendor, mobile operating system, MDM applications installed, company allocations, phone status and MDM activation status. The international call redirector details report can also be filtered by telephone number.

### MDM Settings Page

In some implementations, page selector 802 can be used to select an MDM settings page that allows a user to configure MDM application parameters using a configuration panel, such as parameters for device tracker 310, directory assistance call redirector application 302 and custom call redirector application 306. For device tracker 310, the user can select a capture and send interval, and restrict capturing data during certain hours. For the directory assistance and customer redirector applications, the user can select alternative telephone numbers.

### MDM Orders Page

In some implementations, page selector 802 can be used to select an MDM orders page that allows a user to check the status of pending orders with mobile device vendors or carriers and select new orders. For example, the user can request orders for installing MDM applications via text messaging or enterprise servers, manage or change MDM applications, including enabling or disabling modules with the MDM applications, manage phone configuration and provisioning profiles, query the phone, perform remote wipe or lock and disable MDM applications.

### Reports Page

In some implementations, page selector 802 can be used to select a reports page that allows a user to display invoice reports for mobile services, landline services and total telecom services.

Some examples of invoice reports for mobile services can include but are not limited to: mobile policy audit, mobile cost center allocation (various groupings), mobile usage and charges detail (customer report), mobile service-type charges break-up (graphical), update users to unassigned mobile lines, invoice exception report (mobile invoices), audit mobile device charges, mobile charges trending, mobile device charges trending and mobile average cost per line trending.

Some examples of invoice reports for landline services can include but are not limited to: cost center allocations (landline-various groupings), landline service-type charges break-up (graphical), invoice exception report (landline invoices), update allocations to unassigned landline services, conference call charges, calling card charges, toll free charges, data and Internet charges, dial-up and WiFi charges, efax and Web Fax charges and pager charges.

Some examples of invoice reports for total telecom services can include but are not limited to: GL allocations (mobile and landline invoices), invoice exception report (mobile and landline invoices), invoices accrual report (mobile and landline invoices), invoices pending approval (mobile and landline invoices), invoices pending payment (mobile and landline invoices), audit savings detail (mobile and landline invoices), billing tickets details (mobile and landline), invoice discrepancy details (mobile and landline invoices), total telecom charges trend (graphical), total telecom service charges trend (drill-through report), budget variance report and total telecom users report.

### Mobile Policy Configuration Page

In some implementations, page selector 802 can be used to select a mobile policy configuration page that provides a user with a various mobile policies, including voice policy, data policy, text/SMS/Picture/Video policy and MDM features policy.

The voice policy is a framework for voice usage for various profiles of users in the enterprise. Parameters can include restricting, allowing or partially allowing various voice usages like billable peak minutes, non-billable minutes, mobile-to-mobile usage, international usage, international roaming usage, time of the day usage, etc. Some implementations may include voice policy based on charges for various voice usages.

The data policy is a framework for data usage for various profiles of users in the enterprise. Parameters include restricting, allowing or partially allowing various data usages, international usages, international roaming usage, time of the day usage, etc. Some implementations may include data policy based on charges for various data usages.

The text/SMS/picture/video policy is a framework for text messaging, SMS, pictures and video, mobile TV, E-wallet, mobile applications and ringtone usage for various profiles of users in the enterprise. Parameters can include restricting, allowing or partially allowing various usages, international usages, international roaming usage, time of the day usage, etc. Some implementations may include text messaging, SMS, picture, video, mobile TV, E-wallet, mobile applications and ringtone policy based on charges for those services.

### Subscriber Settings Page

In some implementations, page selector 802 can be used to select a subscriber settings page that provides a grid view of user profiles. The grid view can include name, title, employee ID, title, email, executive status, manager name, finance manager name, site administrator name, company hierarchy, user group and login username. The user can use the grid view to modify user profiles information. Some of this information can be used for role based reporting.

### Exemplary Mobile Device Architecture

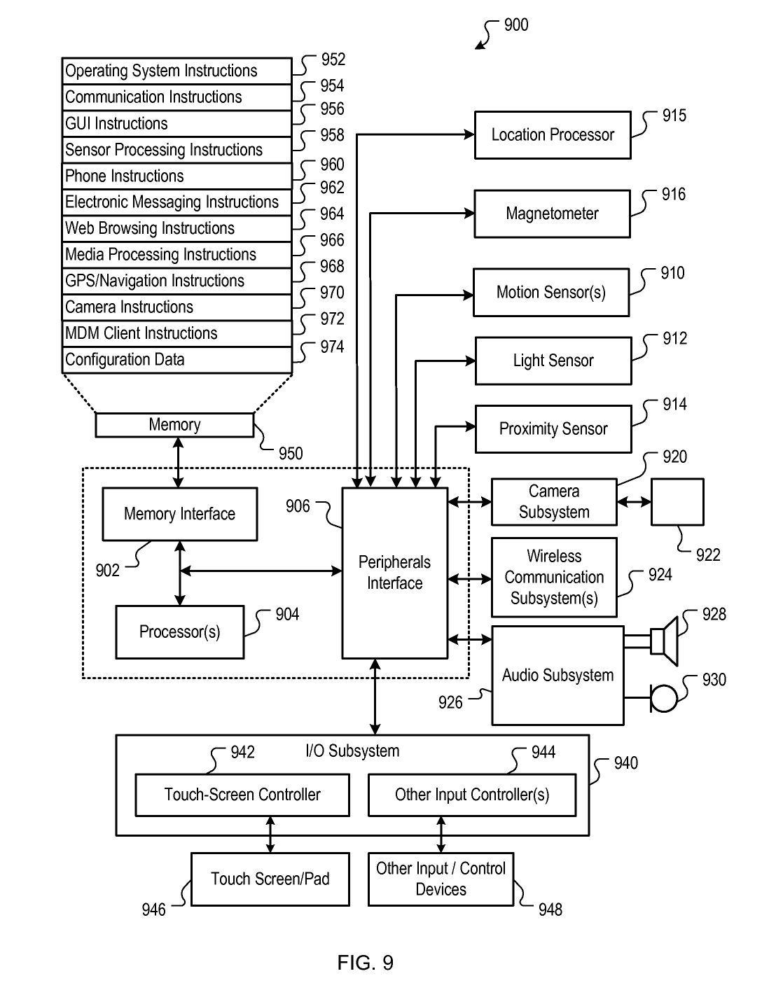

FIG. 9 is a block diagram illustrating exemplary mobile device architecture implementing features and operations described in reference to FIGS. 1-8, 10-12. Device 900 can be any device capable of running software applications and communicating with a remote server computer, including but not limited to smart phones and electronic tablets. Device 900 can include memory interface 902, one or more data processors, image processors or central processing units 904, and peripherals interface 906. Memory interface 902, processor(s) 904 or peripherals interface 906 can be separate components or can be integrated in one or more integrated circuits. The various components can be coupled by one or more communication buses or signal lines.

Sensors, devices, and subsystems can be coupled to peripherals interface 906 to facilitate multiple functionalities. For example, motion sensor 910, light sensor 912, and proximity sensor 914 can be coupled to peripherals interface 906 to facilitate orientation, lighting, and proximity functions of the mobile device. For example, in some implementations, light sensor 912 can be utilized to facilitate adjusting the brightness of touch screen 946. In some implementations, motion sensor 910 (e.g., an accelerometer, gyros) can be utilized to detect movement and orientation of the device 900. Accordingly, display objects or media can be presented according to a detected orientation, e.g., portrait or landscape.

Other sensors can also be connected to peripherals interface 906, such as a temperature sensor, a biometric sensor, or other sensing device, to facilitate related functionalities.

Location processor 915 (e.g., GPS receiver) can be connected to peripherals interface 906 to provide geo-positioning. Electronic magnetometer 916 (e.g., an integrated circuit chip) can also be connected to peripherals interface 906 to provide data that can be used to determine the direction of magnetic North. Thus, electronic magnetometer 916 can be used as an electronic compass.

Camera subsystem 920 and an optical sensor 922, e.g., a charged coupled device (CCD) or a complementary metal-oxide semiconductor (CMOS) optical sensor, can be utilized to facilitate camera functions, such as recording photographs and video clips.

Communication functions can be facilitated through one or more communication subsystems 924. Communication subsystem(s) 924 can include one or more wireless communication subsystems. Wireless communication subsystems 924 can include radio frequency receivers and transmitters and/or optical (e.g., infrared) receivers and transmitters. Wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data. The specific design and implementation of the communication subsystem 924 can depend on the communication network(s) or medium(s) over which device 900 is intended to operate. For example, a mobile device can include communication subsystems 924 designed to operate over a GSM network, a GPRS network, an EDGE network, a WiFi or WiMax network, and a Bluetooth network. For example, device 900 may include wireless communication subsystems designed to operate over a global system for mobile communications (GSM) network, a GPRS network, an enhanced data GSM environment (EDGE) network, 802.x communication networks (e.g., WiFi, WiMax, or 3G networks), code division multiple access (CDMA) networks, and a Bluetooth™ network. Communication subsystems 924 may include hosting protocols such that the mobile device may be configured as a base station for other wireless devices. As another example, the communication subsystems can allow the device to synchronize with a host device using one or more protocols, such as, for example, the TCP/IP protocol, HTTP protocol, UDP protocol, and any other known protocol.

Audio subsystem 926 can be coupled to a speaker 928 and one or more microphones 930 to facilitate voice-enabled functions, such as voice recognition, voice replication, digital recording, and telephony functions.

I/O subsystem 940 can include touch screen controller 942 and/or other input controller(s) 944. Touch-screen controller 942 can be coupled to a touch screen/pad 946. Touch screen/pad 946 and touch screen controller 942 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with touch screen/pad 946.

Other input controller(s) 944 can be coupled to other input/control devices 948, such as one or more buttons, rocker switches, thumb-wheel, infrared port, USB port, and/or a pointer device such as a stylus. The one or more buttons (not shown) can include an up/down button for volume control of speaker 928 and/or microphone 930.

In one implementation, the user may be able to customize a functionality of one or more of the buttons. The touch screen/pad 946 can also be used to implement virtual or soft buttons and/or a keyboard.

In some implementations, device 900 can present recorded audio and/or video files, such as MP3, AAC, and MPEG files. In some implementations, device 900 can include the functionality of an MP3 player and may include a pin connector for tethering to other devices. Other input/output and control devices can be used.

Memory interface 902 can be coupled to memory 950. Memory 950 can include high-speed random access memory or non-volatile memory, such as one or more magnetic disk storage devices, one or more optical storage devices, or flash memory (e.g., NAND, NOR). Memory 950 can store operating system 952, such as Darwin, RTXC, LINUX, UNIX, OS X, WINDOWS, or an embedded operating system such as VxWorks. Operating system 952 may include instructions for handling basic system services and for performing hardware dependent tasks. In some implementations, operating system 952 can include a kernel (e.g., UNIX kernel).

Memory 950 may also store communication instructions 954 to facilitate communicating with one or more additional devices, one or more computers or one or more servers. Communication instructions 954 can also be used to select an operational mode or communication medium for use by the device, based on a geographic location (obtained by the GPS/Navigation instructions 968) of the device. Memory 950 may include graphical user interface instructions 956 to facilitate graphical user interface processing; sensor processing instructions 958 to facilitate sensor-related processing and functions; phone instructions 960 to facilitate phone-related processes and functions; electronic messaging instructions 962 to facilitate electronic-messaging related processes and functions; web browsing instructions 964 to facilitate web browsing-related processes and functions; media processing instructions 966 to facilitate media processing-related processes and functions; GPS/Navigation instructions 968 to facilitate GPS and navigation-related processes and instructions; camera instructions 970 to facilitate camera-related processes and functions; MDM instructions 972 and configuration data 974 (including subscriber plan and mobile policy information), for the processes and features described with reference to FIGS. 1-8, 10-12. The memory 950 may also store other software instructions for facilitating other processes, features and applications.

Each of the above identified instructions and applications can correspond to a set of instructions for performing one or more functions described above. These instructions need not be implemented as separate software programs, procedures, or modules. Memory 950 can include additional instructions or fewer instructions. Furthermore, various functions of the mobile device may be implemented in hardware and/or in software, including in one or more signal processing and/or application specific integrated circuits.

### Secure, Private Voice or Data or Video or Messaging Communications

FIG. 10 is an exemplary operating environment 100 for secure, private voice communications. In some implementations, enterprise administrators are able to manage voice and data communications between client devices associated with the enterprise. Through a user interface (e.g., Web page) provided by TIMS 114, an enterprise administrator can specify a set of rules that must be complied with before a client device can be added to a group or be allowed to interface with other client devices in the group. In the example shown, client devices 102a, and client devices 102b are in groups 1000, 1002, respectively as indicated by the dashed lines. Each group can be associated by TIMS 114 with an enterprise 112. Any number of groups of client devices can be formed for a single enterprise. Each group can have its own set of rules or there can be a single set of rules for all groups belonging to an enterprise.

When a client device of group 1000 attempts to communicate with another client device of group 1000, private communications 320 checks a database to determine whether the client device complies with a set of rules specified by an enterprise administrator for group 1000. Some examples of rules include: determining if the device is associated with the enterprise; determining if the device is on a list of client devices that are prohibited from participating in voice or data communication with other client devices in the group; determining if the device has installed a minimum version of its mobile operating system; determining if the device has installed prohibited applications; and determining if the device is in a predefined geographic region (e.g., within a geofence specified by the enterprise administrator).

If the client device is compliant with the set of rules, voice and/or data connection is established by TIMS 114, using a virtual PBX. The virtual PBX is software that can manage phone tasks such as call routing, allowing more than one person to be reached from a single number, voicemail, faxing, automated greetings, conference calling, and sending phone calls to the first available person in a group. In some implementations, the connection established by TIMS 114 can be conference call or chat session between two or more devices in the group. In such use scenarios, each client device of the group will need to comply with the set of rules specified for the group. The virtual PBX can be implemented using open source software, such as Asterisk®.

FIG. 11 is a flow diagram of an exemplary process 1100 of managing secure, private voice communications. Process 1100 can be implemented in, for example, Private Voice Communications 320 in mobile device management 216, as shown in FIGS. 2 and 3.

In some implementations, process 1100 can begin by receiving a request from a first client device to communicate with a second client device in a group of client devices associated with an enterprise (1102). Client devices can be associated with a group through a user interface presented on a computer that is operated by an enterprise administrator.

Process 1100 can continue by determining that the first and second client devices comply with a set of rules for the group that are specified by an administrator of the enterprise (1104). Some examples of rules include: determining if the first and second devices are associated with the enterprise; determining if the first or second device is on a list of client devices that are prohibited from participating in voice or data communication with client devices in the group; determining if the first and second devices have installed a minimum version of a mobile operating system; determining if the first and second devices have installed prohibited applications; and determining that the first device and the second device are in a predefined geographic region.

Process 1100 can continue by establishing voice and data communication between the first client device and the second client device (1106). Voice and data communication can be established using a virtual PBX, as previously described. In some implementations, a conference call or video call or chat session can be established between two or more client devices, each of which complies with the set of rules specified for the group.

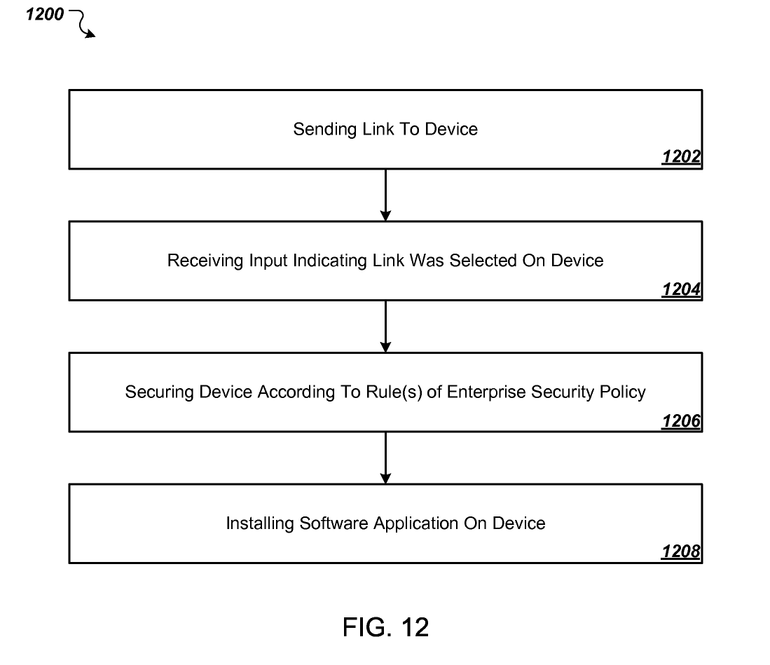

FIG. 12 is a flow diagram of an exemplary process performed by a server computer for securely enrolling a device for communications with other devices in a group managed by TIMS 114. Process 1200 can be implemented in, for example, Private Voice Communications 320 in mobile device management 216, as shown in FIGS. 2 and 3.

In some implementations, process 1200 can be implemented by establishing communication with a device (1202) and sending a link to the device (1204). For example, a link can be sent in an e-mail or text message to the device over a wireless network.

Process 1200 can continue by receiving input indicating the link was selected at the device (1206). For example, the input can be the user clicking on the link in the e-mail or text message.

Process 1200 can continue by securing the device according to a first set of rules implementing an enterprise security policy (1208). For example, an identifier for the device (e.g., telephone number) can be checked against a “black list” of devices to determine if the device is restricted from receiving software. In addition, the version of the operating system can be checked to ensure that it is up to date.

Process 1200 can continue by determining that the device is secure (1210), installing a software application on the device (1212), the software including a second set of rules for communicating with other devices in a group of devices associated with the enterprise.

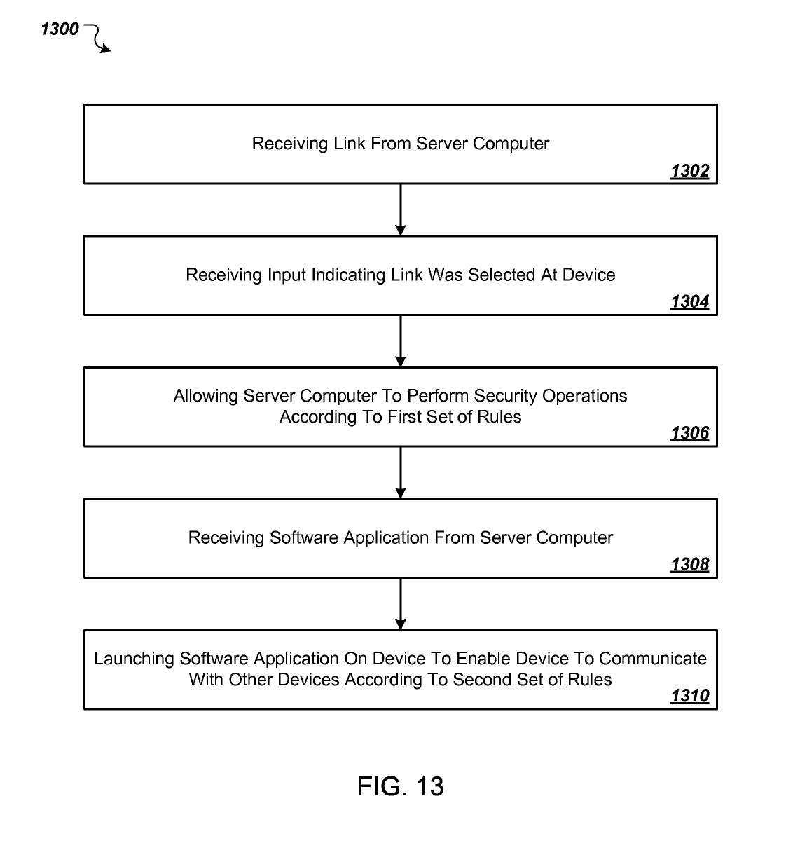

FIG. 13 is a flow diagram of an exemplary process 1300 performed by a device to securely enroll the device for communications with other devices in a group managed by TIMS 114.

In some implementations, process 1300 can begin by establishing communication with a server computer (1302) and receiving a link from the server computer (1304). For example, the device can receive an e-mail containing a link that can be selected by a user of the device.

Process 1300 can continue by receiving input indicating the link was selected at the device (1306). The input can be, for example, a user input selecting the link from an e-mail.

Process 1300 can continue by allowing the server computer to perform security operations on the device according to a first set of rules implementing an enterprise security policy (1308).

Process 1300 can continue by receiving a software application from the server computer, the software including a second set of rules for communicating with other devices in a group of devices associated with the enterprise (1310).

Process 1300 can continue by launching the software application on the device to enable the device to communicate with the other devices according to the second set of rules (1312).

In some implementations, a login credentials supported container application can be created on devices for initiating or terminating voice, data or messaging communications. The container application can include a set of classes, libraries and other files required for execution on the device. The container application can manage client software application execution on the device and use necessary system resources to enable application functionality. In some implementations, the container application can ensure the security of the device by collecting user authentication data, such as username and password and sending the collected data to a TIMS server through, for example, a Java Remote Method Invocation (RMI) interface over the Internet Inter-Orb Protocol (IIOP) (RMI/IIOP). The authentication data can be processed by the TIMS server independently using a Java Authentication and Authorization Service (JAAS) module or using a server technology related to Active Directory or Light Directory Active Protocol (AD, LDAP).

In some implementations, the container application can encrypt a call, including encrypting the signaling of the call or the call data or both. The container application can save encrypted voice mail and voice call recordings. The container application can determine if the call would travel over a public network or a private IP network based on a set of rules, and then set-up the call according to the set of rules.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to, communicate with, one or more mass storage devices for storing data files; such devices include magnetic disks, such as internal hard disks and removable disks; magneto-optical disks; and optical disks.

Storage devices suitable for tangibly embodying computer program instructions and data include all forms of non-volatile memory, including by way of semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a player, the features can be implemented on a computer having a display device, such as a CRT (cathode ray tube) or LCD (liquid crystal display) monitor for displaying information to the player. The computer can also have a keyboard and a pointing device such as a game controller, mouse or a trackball by which the player can provide input to the computer.

The features can be implemented in a computer system that includes a back-end component, such as a data server, that includes a middleware component, such as an application server or an Internet server, or that includes a front-end component, such as a client computer having a graphical mobile subscriber interface or an Internet browser, or any combination of them. The components of the system can be connected by any form or medium of digital data communication such as a communication network. Some examples of communication networks include LAN, WAN and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
receiving a request from a first client device to communicate with a second client device in a group of client devices associated with an enterprise;
determining that the first and second client devices comply with a set of rules for the group that are specified by an administrator of the enterprise; and
establishing voice or data or video or messaging communication between the first client device and the second client device,
where the method is performed by one or more hardware processors.

2. The method of claim 1, wherein determining that the first and second client devices comply with the set of rules further comprises:
determining if the first and second devices are associated with the enterprise.

3. The method of claim 1, wherein determining that the first and second client devices comply with the set of rules further comprises:
determining if the first or second device is on a list of client devices that are prohibited from participating in voice or data or video or messaging communication with client devices in the group.

4. The method of claim 1, wherein determining that the first and second client devices comply with the set of rules further comprises:
determining if the first and second devices have installed a minimum version of a mobile operating system.

5. The method of claim 1, wherein determining that the first and second client devices comply with the set of rules further comprises:
determining if the first and second devices have installed prohibited applications.

6. The method of claim 1, wherein determining that the first and second client devices comply with the set of rules further comprises:
determining that the first device and the second device are in a predefined geographic region.

7. The method of claim 1, wherein the voice or video communication is a conference call between the first device, the second device and one or more other devices in the group.

8. The method of claim 1, further comprising:
requesting login credentials from the first or second client device.

9. A system comprising:
a network interface coupled to a wide area network and configured for coupling to a computer operated by an enterprise;
a processor coupled to the network interface;
memory coupled to the processor and configured for storing instructions, which when executed by the processor, causes the processor to perform operations comprising:
receiving a request from a first client device to communicate with a second client device in a group of client devices associated with the enterprise;
determining that the first and second client devices comply with a set of rules for the group that are specified by an administrator of the enterprise; and
establishing voice or data or video or messaging communication between the first client device and the second client device.

10. The system of claim 9, further comprising:
a database coupled to the processor and configured for storing the set of rules.

11. The system of claim 9, where the memory includes instructions, which when executed by the processor, causes the processor to perform the operations of:
receiving the set of rules from the enterprise from the wide area network; and
storing the set of rules in a database coupled to the processor.

12. The system of claim 9, wherein determining that the first and second client devices comply with the set of rules further comprises:
determining if the first and second devices are associated with the enterprise.

13. The system of claim 9, wherein determining that the first and second client devices comply with the set of rules further comprises:
determining if the first or second device is on a list of client devices that are prohibited from participating in voice or data or video or messaging communication with client devices in the group.

14. The system of claim 9, wherein determining that the first and second client devices comply with the set of rules further comprises:
determining if the first and second devices have installed a minimum version of a mobile operating system.

15. The system of claim 9, wherein determining that the first and second client devices comply with the set of rules further comprises:
determining if the first and second devices have installed prohibited applications.

16. The system of claim 9, wherein determining that the first and second client devices comply with the set of rules further comprises:
determining that the first device and the second device are in a predefined geographic region.

17. The system of claim 9, wherein the voice or video communication is a conference call between the first device, the second device and one or more other devices in the group.

18. The system of claim 9, further comprising:
requesting login credentials from the first or second client device.

19. A method comprising:
establishing communication with a device;
sending a link to the device;
receiving input indicating the link was selected at the device;
responsive to the input, securing the device according to a first set of rules implementing an enterprise security policy; and
installing a software application on the device, the software including a second set of rules for communicating with other devices in a group of devices associated with the enterprise,
where the method is performed by one or more hardware processors.

20. The method of claim 19, further comprising:
creating a login credentials supported container application on the device for initiating or terminating voice, data or messaging communications.

21. A method comprising:
establishing communication with a server computer;
receiving a link from the server computer;
receiving input indicating the link was selected at the device;
responsive to the input, allowing the server computer to perform security operations according to a first set of rules implementing an enterprise security policy;
receiving a software application from the server computer, the software including a second set of rules for communicating with other devices in a group of devices associated with the enterprise; and
launching the software application on the device to enable the device to communicate with the other devices according to the second set of rules,
where the method is performed by one or more hardware processors.

22. The method of claim 21, further comprising:
after launching, detecting a violation of the one or more rules of the second set of rules; and
performing a preventative action based on the detecting.

23. The method of claim 21, further comprising:
remotely controlling the container on the device to enable, disable, change or wipe the application on the device.

24. A system comprising:
a processor coupled to the network interface;
memory coupled to the processor and configured for storing instructions, which when executed by the processor, cause the processor to perform operations comprising:
establishing communication with a device;
sending a link to the device;
receiving input indicating the link was selected at the device;
responsive to the input, securing the device according to a first set of rules implementing an enterprise security policy; and
installing a software application on the device, the software including a second set of rules for communicating with other devices in a group of devices associated with the enterprise.

25. A system of claim 24, further comprising:
creating a login credentials supported container application on the device for initiating or terminating voice, data or messaging communications.

26. A system comprising:
a processor coupled to the network interface;
memory coupled to the processor and configured for storing instructions, which when executed by the processor, causes the processor to perform operations comprising:
establishing communication with a server computer;
receiving a link from the server computer;
receiving input indicating the link was selected at the device;
responsive to the input, allowing the server computer to perform security operations according to a first set of rules implementing an enterprise security policy;
receiving a software application from the server computer, the software including a second set of rules for communicating with other devices in a group of devices associated with the enterprise; and
launching the software application on the device to enable the device to communicate with the other devices according to the second set of rules.

27. A system of claim 26, further comprising:
remotely controlling the container on the device to enable, disable, change or wipe the application on the device.

28. The system of claim 26, further storing instructions, which when executed by the processor, causes the processor to perform operations comprising:
after launching, detecting a violation of the one or more rules of the second set of rules; and
performing a preventative action based on the detecting.
